(19) United States
(12) Patent Application Publication
(10) Pub. No.: US 2026/0087574 A1
(43) Pub. Date: Mar. 26, 2026

(54) SYSTEM AND METHOD FOR MANAGING ESTATE DOCUMENTS

(71) Applicant: TrustSafe, LLC, St. George, UT (US)

(72) Inventor: Christine Alleman, St. George, UT (US)

(21) Appl. No.: 18/891,336

(22) Filed: Sep. 20, 2024

(51) Int. Cl. G06Q 50/18

(52) U.S. Cl. CPC G06Q 50/186

(57) ABSTRACT

A computer-implemented method enables online storage of estate documents in a computer system. Access to such estate documents and information in the estate documents is limited to authorized persons via security protocols. However, a publicly-accessible interface enables database searches to determine whether estate documents of a particular testator are stored on the system. Such searches may require the inquiring party (inquirer) to enter information about the testator and information about themselves. A search will identify a hit only if a record is identified in the name of the testator and the inquirer is a named party in the estate documents.

### BACKGROUND

The present disclosure relates to the field of electronic storage of documents

Estate documents, such as wills and trusts, are important in properly and efficiently disposing of a person's assets after their death. Such estate documents often are created several years before the death of the testator or trustor, and it is not uncommon for estate documents to be lost or to be damaged between the time of their creation and the death of the testator or trustor. Also, testators and trustors often use lawyers to draft such documents, and sometimes leave the documents in the care of the lawyer. However, after the passage of time, the lawyer may retire or switch firms, the testator's records of who is the custodian of such documents and where they are located may be lost, and the beneficiaries of the estate documents may not know where to find such documents or know who may be charged with their keeping.

It is known to save estate documents in a computer database. However, legal requirements to make such documents valid and enforceable vary from state to state, and electronic documents cannot function as valid estate documents in some states. Further, estate documents can be extremely sensitive, and it is usually desired that they be protected by security measures. But such security measures may render such estate documents unavailable to beneficiaries upon the death of the testator/trustor.

### SUMMARY

The present specification provides a method an apparatus for storing estate documents while satisfying competing needs of security during the life of the testator and accessibility upon the death of the testator. Estate documents often are considered sensitive, and thus it can be desired to limit access to such documents, and even to information regarding parties named in the documents, particularly when the testator is living. However, to be useful estate documents need to be locatable and accessible upon the testator's death, even to individuals who were not given access during the testator's life. Thus, a competing need is for named parties that previously were barred from access to be able to find and obtain copies of such estate documents after the testator's death. Such location and access should be available even if location and security access information dies with the testator. The present specification presents inventive aspects of a computer-based system and method configured to accomplish such competing goals.

In accordance with one embodiment, a computer-implemented method is provided. The method includes storing, in a first database, an estate document, a testator information about a testator associated with the estate document and a named party information, the estate document having one or more named parties. The testator information testator comprises a testator name, a testator vital information, and a testator non-vital information. The named party information includes a name of each of the one or more named parties, and a capacity of each of the one or more named parties. The method further includes storing, in a second database, a copy of at least a portion of the testator information and the named party information that is stored in the first database and receiving an online search request from an inquirer. The online search request comprise a search testator name, a search testator vital information, and the inquirer name. The method further includes performing a search in response to the search request, wherein performing the search comprises reviewing the second database and not the first database. During the search it can be determined that the search testator name matches the testator name, the search testator vital information matches the testator vital information, and the inquirer name matches at least one of the names of the one or more named parties as stored in the second database. If this is the case, the method includes outputting an acknowledgement that the estate document is stored in the database and that the inquirer is one of the one or more named parties.

Another embodiment comprises receiving the estate document, testator information and named party information via a secured interface and storing, in the first database, the estate document, testator information and named party information using a security protocol and apparatus that limits access to qualified accounts.

One such embodiment comprises pushing at least a portion of the testator information and named party information from the first database to the second database. The second database can be blocked from initiating communication with the first database.

Still another embodiment can additionally comprise outputting the capacity of the inquirer. A further such embodiment can additionally comprise notifying a testator user account that the system has outputted the acknowledgement that the estate document is stored in the database and that the inquirer is one of the one or more named parties.

In some embodiments the named party information pushed to the second database is only non-vital information.

In accordance with another embodiment, a computer-implemented method is provided, comprising storing, in a database, an estate document, a testator information about a testator associated with the estate document and a named party information, the estate document having one or more named parties. The information about the testator comprises a testator name, a testator vital information, and a testator non-vital information. The named party information includes a name of each of the one or more named parties, and a capacity of each of the one or more named parties. The method further comprises receiving an online search request from an inquirer, the online search request comprising a search testator name, a search testator vital information, and the inquirer name, and determining that the search testator name matches the testator name, the search testator vital information matches the testator vital information, and the inquirer name matches at least one of the names of the one or more named parties. In such case the method includes outputting an acknowledgement that the estate document is stored in the database and that the inquirer is one of the one or more named parties.

Some embodiments additionally comprise the inquirer entering a relationship between the inquirer and the testator. In other such embodiments, the named party information includes a stored relationship between each of the one or more named parties and the testator.

Still further embodiments additionally comprise determining that the relationship entered by the inquirer matches the stored relationship between the testator and the at least one of the names of the one or more named parties.

Yet another embodiment includes copying to a second database at least some of the testator information and at least some of the named party information and searching the second database in the step of determining that the search testator name matches the testator name, the search testator vital information matches the testator vital information, and the inquirer name matches at least one of the names of the one or more named parties.

Some such embodiments can comprise receiving the online search request via a publicly-accessible search portal that can be accessed without requiring security credentials.

### BRIEF DESCRIPTION OF THE DRAWINGS

FIG. 1 is a schematic view of a computing environment configured to employ aspects of embodiments;

FIG. 2 is a schematic view showing relationships between computing environments in accordance with an embodiment;

FIG. 3 is a flow diagram of a method in accordance with some embodiments; and

FIG. 4 is a flow diagram of further steps of a method in accordance with some embodiments.

### DESCRIPTION

The present specification describes inventive aspects in the context of certain embodiments. It is to be understood that inventive aspects described herein can be employed in various configurations of computer systems having different specific designs and configurations.

A will is a document that dictates the disposition of the assets of a testator in the event of their death. The validity of any particular will document typically is determined by state law. At present some, but not all, state laws allow digitally stored wills to be valid and enforceable. However, in such states certain requirements concerning digitally stored wills must be met for the digitally stored will to be valid and enforceable. Similarly, other documents used for estate planning, such as trusts and powers of attorney, and even health care directives, can often be valid and enforceable when digitally stored as long as certain legal requirements are met. For purposes of this specification, estate planning documents such as wills and trusts, together with any other documents to make such documents valid when digitally stored, are included in the term “estate documents”. Additionally, although the person whose assets are being distributed by a trust is technically a “trustor”, for efficient reference in this specification both a testator and trustor will be collectively referred to as a “testator”.

Preparing estate documents often involves working with a professional services provider such as an attorney, but can also be performed by a testator working on their own. Preparing estate documents can be performed in various ways, including traditional pen and paper, word processing, and/or online digital preparation using prompts and online forms. For each mode of preparation, the estate documents can be scanned, authenticated, or otherwise prepared for online storage.

Estate documents can be stored online. However, such estate documents often are considered sensitive, and thus are often intended to be securely held and only accessible to authorized persons, particularly when the testator is living. Such authorized persons typically include the testator, but may not include anyone else, and may not include any or at least some of the individuals specifically named in the estate document as having a role in the testator's estate. However, by their very nature, estate documents are specifically intended to be accessible to at least certain named individuals upon the testator's death, even if those individuals were not to have access during the testator's life. Thus, a competing need is for named parties that previously were barred from access to be able to find and obtain copies of such estate documents after the testator's death, even if security access information or custodian information (such as the identify of the responsible lawyer) dies with the testator. The present specification presents inventive aspects of a computer-based system and method configured to accomplish such competing goals.

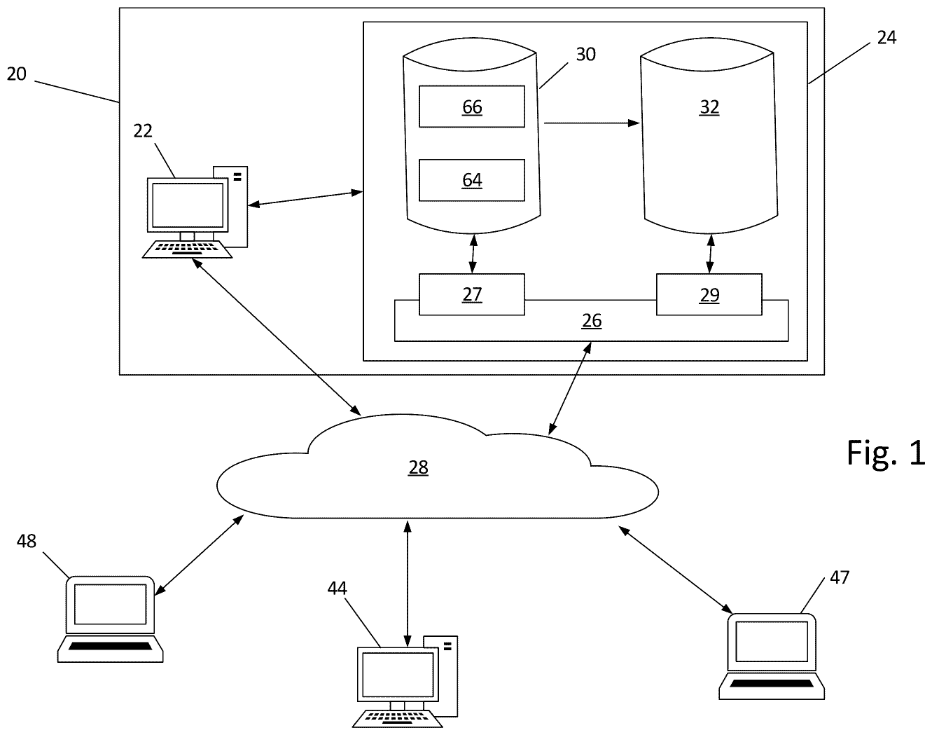

With initial reference to FIG. 1, an administrator computing environment 20 comprises an administrator computer system 22 having a processor and electronic memory structures and being configured to communicate with a server system 24 comprising one or more servers. The server system 24 includes one or more processors and hardware, including memory structures, configured to provide computer processing and electronic storage capabilities, as well as installed software configured to perform functions as described herein. Along these lines, the server system 24 is configured to define and operate a web interface 26 configured to communicate with one or more computer networks and other computer systems via a network such as, for example, the internet 28. The server system defines a first database 30 and a second database 32 that are configured to selectively communicate with the web interface 26 and each other as will be discussed in more detail below.

The administrator computer system 22 is configured to communicate with the server system 24, and thus with the first database 30 and second database 32. Such communication can be via a direct, wired connection, a wireless communication system, a localized network such as a LAN, and/or via other network structures such as the internet 28. Preferably, the administrator computer system 22 is configured to access the server 24, and its associated databases 30, 32 and web interface 26, via a secured connection employing securement structures and strategies such as password protection, multi-factor verification and/or other credentialing strategies. As such, the administrator computer 22 can access, read, upload, and download data structures within the databases 30, 32. The administrator computer 22 can also access, monitor, control, adjust, and perform other administrative functions concerning the web interface 26.

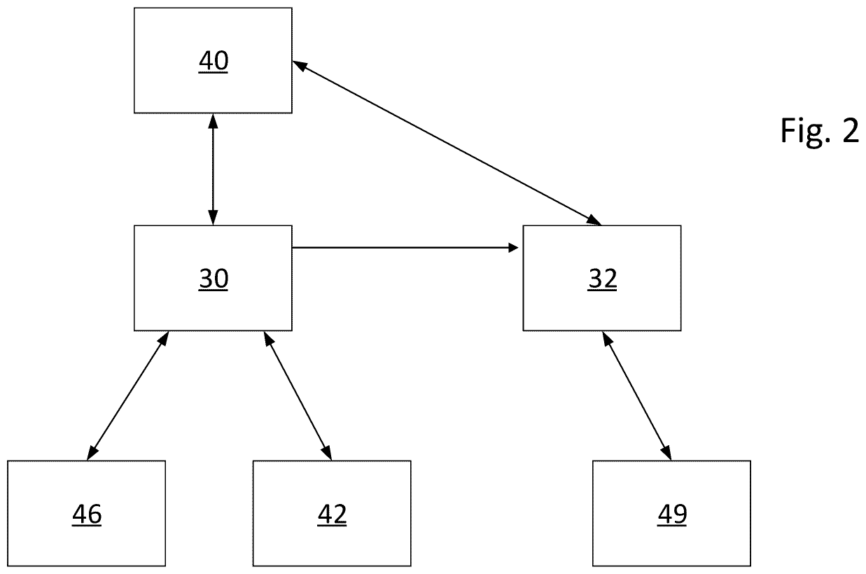

With continued reference to FIG. 1 and additional reference to FIG. 2, access by the administrator computer 22 can be made via an administrator account 40 that can be maintained by the server system 24 and can be accessed via the security structures as discussed above. As such, in some embodiments the administrator computer 22 can be a remote computing device 47 configured to access the server system 24 via the administrator account 40, rather than being limited to a specific computer.

In the illustrated embodiment the first database 30 is configured with security structures to protect its contents from unauthorized access, even from the second database 32. Such security structures can entail both software and hardware aspects. For example, in some embodiments the first database 30 can be maintained in and by a first server while the second database 32 can be maintained in and by a second server. Various structures and strategies can be employed to harden the first database 30, including firewalls, data encryption, segregation of tables, and the like. In contrast, the second database 32 has at least some data structures that can be accessed without substantial security protections, or at least with less aggressive security structures than are provided for the first database 30.

With continued reference to FIGS. 1 and 2, a professional services provider such as an attorney and an associated law firm can maintain a custodian account 42 configured to access the computing environment 20 via the internet 28. A custodian computer 44 can comprise one or more networked and/or remote computers controlled by staff of the custodian. Such custodian can be a person or organization charged with maintaining the estate documents while the testator is still alive. The custodian can comprise a professional services provider such as a law firm, accountant, or estate document handling company. Agents of the custodian can use the computer 44 to access the custodian account 42 via the internet 28 by accessing the web interface 26. A secure portal 27 of the web interface 26 is configured to allow a properly-credentialed user to log into the custodian account 42. The custodian account 42 preferably is security-enabled to require appropriate credentials such as by requiring a password and possibly multi factor authentication prior to providing access to the first database 30.

A user account 46 attributable to an individual testator can also be established in the computing environment 20 and accessible via a user computer 48 that is capable of accessing the web interface 26 and secure portal 27. In order for the user computer 48 to access the user account 46, security structures such as credential requirements including passwords and/or multi factor authentication can be provided so as to enable the user/testator to access the secure user account 46 in the first database 30 via the secure portal 27. By using appropriate credentials, the user can also access the user account 46 using a remote computer 47. In some embodiments a custodian agent can access the custodian account 42 via a remote computer 47.

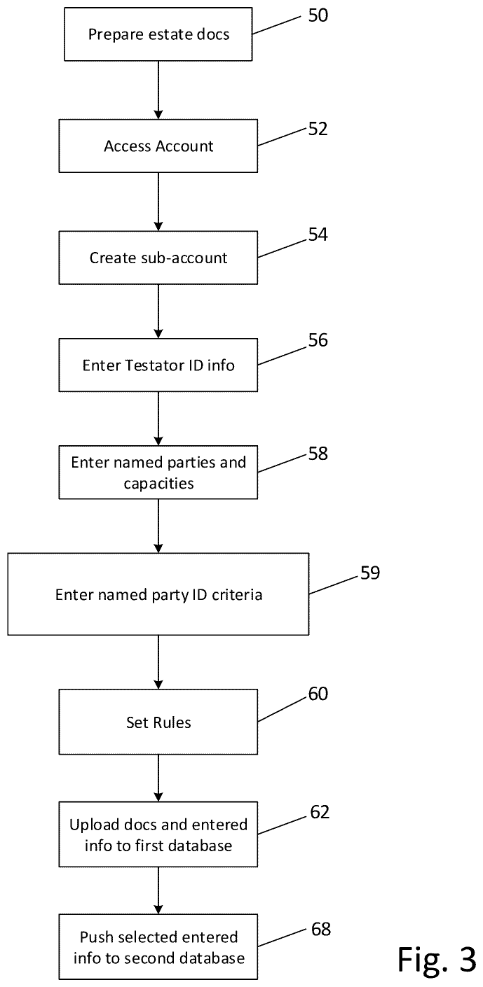

With additional reference to FIG. 3, an example will be discussed in which a testator employs a professional services firm to prepare estate documents, at step 50. Once the estate documents are prepared, an agent of the firm can access the web interface 26 secure portal 27 and log in 52 to their custodial account 42. The custodian account 42 is configured to serve such a professional services firm that works with a plurality of testators, and thus is configured to have several sub-accounts, including a sub-account for each testator. The firm agent can create 54 a sub-account for a particular testator.

The web interface 26 within the secure portal 27 will present a series of queries 56 in connection with the testator sub-account, including requesting information about the testator, including both vital information and information that can be publicly available. For example, the testator's name will be entered, as well as a small amount of vital information, such as the testator's date of birth. Other, non-vital, information can also be entered, such as the testator's city of residence as of the date of sub-account creation, and also genealogical information such as the names of the testator's parents and children.

Estate documents usually discuss specific people who have roles in the estate, such as beneficiaries, executors, and the like. The web interface 26 within the secure portal 27 will prompt entry 58 of information about each party named in the estate documents, as well as the capacity(ies) for which that particular party is named. This information includes the name of the party and their particular role or capacity in the estate documents. Capacities can include, for example, testator, executor, alternate executor, trustor, trustee, successor trustee, alternate successor trustee, beneficiary, and disinherited. In some versions a named party can be associated with more than one capacity. Such named party and associated capacity information is entered 58 into the appropriate sub-account via the secure portal 27.

Criteria for identifying each named party will also be entered 59 via the secure portal 27. While such criteria can include vital information such as dates of birth and social security numbers, more preferably the identification criteria comprises non-vital information such as genealogical information including the named party's relationship to the testator, names of the named party's parents, and the like.

For purposes of this specification, vital information is considered to be non-public information expected to be found on vital government records such as a birth certificate, marriage certificate, and social security card. Such vital information, then would include a date of birth, date of marriage and social security number. Non-vital information is also personal but not necessarily non-public. Examples of non-vital information would include genealogical information such as names of parents, grandparents and children, as well as a state or city of residence.

The testator can be presented with some options, or rules, for how their account will be treated. In particular, the testator will be prompted to enter 60 a decision whether or not to enable public release of the capacity(ies) of named parties from the will. The implications of this decision will be discussed in more detail below.

Data concerning the estate documents and associated estate information can then be uploaded 62 to the first database 30. Preferably the estate documents will be saved in a documents storage portion 64 of the first database 30, while the entered information can be saved in information tables 66 of the first database 30. Data in the information tables 66 will be linked to the associated estate documents saved in the documents storage portion 64. For example, a record number can be assigned to data concerning a particular testator. As noted above, all of this information in the first database 30 can only be accessed via security-protected processes and structures such as password protections.

Once all the party information is entered and saved in the information tables 66 of the first database 30, a copy of selected party information data, which can include the record number, can be pushed 68 to the second database 32, depending on the rules set by the testator at step 60. Preferably this push 68 of information originates from instructions at the first database 30 when the secure portal 27 indicates that documents and information have been uploaded 62, and the push 68 does not take place in response to any request, or any other communication, from the second database 32 or a public portal 29 of the web interface 26.

Data concerning the testator and associated estate documents and information saved in the first database 30 is accessible via the custodian account 42 upon satisfaction of security verifying processes such as a password. In preferred embodiments, the testator is provided their own user account 46, which can also access such documents and information using credentialed access, such as password-protected access, to the first database 30.

In some embodiments the testator can perform the steps described in connection with FIG. 3 without the assistance of a professional services firm. In such embodiments the testator would access the web interface 26 via the secure database 27, create 54 and sign in to a user account, and enter 56, 58 testator information as well as named party information directly through their user account 46 and user computer 48. The testator can also set 60 or adjust rules.

As stated previously, one purpose of the system and method is to securely store estate documents in a manner that such documents are kept from unintentional distribution. A competing purpose is to avoid the risk that such estate documents will be lost or forgotten, or that access to the estate documents can be prevented if credentials (such as password) for the user account 46 are lost upon the death of the testator or people that may have been close enough to the testator to have been given security credential information. For example, the estate documents may not be needed or used for a decade or more after their creation. In the meantime a lawyer who helped create the estate documents may have retired or passed away. Other individuals close to the testator, and perhaps even parties named in the will, may have passed away or forgotten or lost details such as credentials that would allow them to access the testator's user account 48. This specification describes aspects of embodiments that enable individuals without password credentials or other vital information to learn about relevant estate documents without exposing the contents of such estate documents or otherwise compromising security.

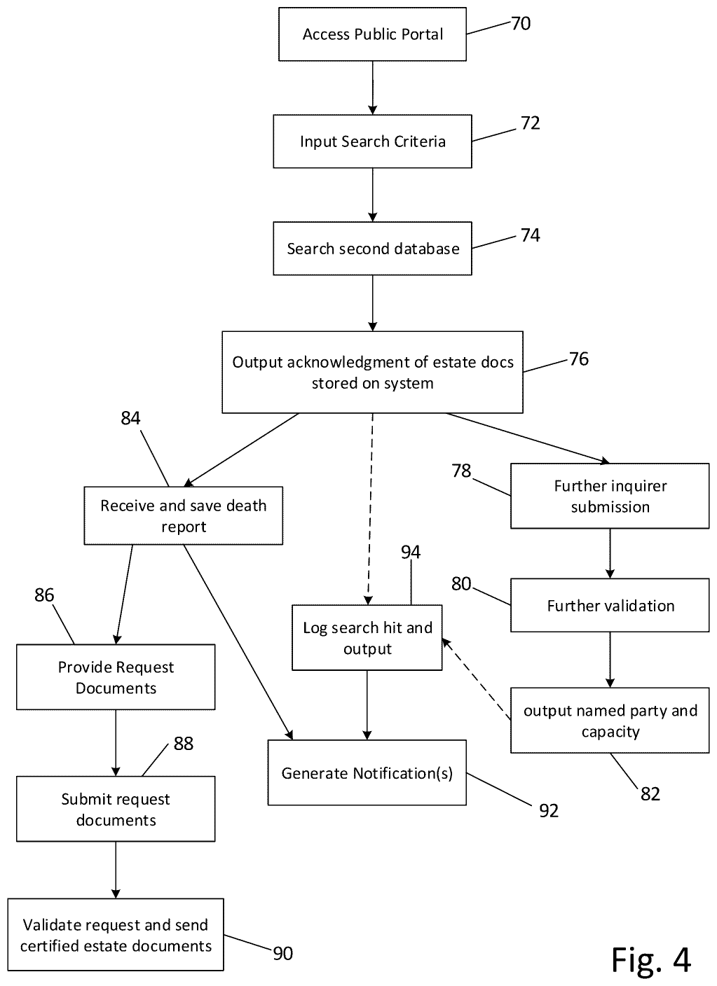

With reference next to FIG. 4, an individual without any security access to the custodian account 42 or user account 46 can nonetheless inquire whether the administrator system 20 is storing estate documents of a particular testator and whether the inquiring individual (inquirer) is a named party in the estate documents. This can be done without any password or other credentials concerning the estate documents. In one embodiment, the inquirer first accesses 70 a public portal 29 of the web interface 26 and engages a public search option. The inquirer can use any of a range of computing devices 47 to make such access. The inquirer will be prompted to enter 72 certain identification information about the testator, most importantly the testator's first and last names, which information can be held in an inquirer account 49, which can be a temporary account established on the second database 32. In the illustrated embodiment the public portal 29 can display a prompt that will also include a request for the testator's date of birth and/or non-vital information. A requirement that the inquirer have at least some vital information about the testator makes it more likely that the inquirer is a related or appropriately-interested party.

A search 74 can performed to see whether estate documents matching the information entered about the testator are saved on the administrator system 20. Depending on how common the testator's name is, there may be more than one hit. If the provided information is incorrect, or if there are no estate documents for the listed testator, the search will simply output that no estate documents meeting the search criteria have been found. If more than one testator's estate documents meet the criteria, the inquirer can be prompted to enter additional information, such as the testator's state and/or city of residence, a middle initial or middle name, or genealogical information such as the names of the testator's parents. Such information may be employed to narrow down search results until it can be determined that only one set of estate documents for a testator meeting the identification criteria is stored on the administrator's system 20. If such a matching set of estate documents is identified, the system will output 76 a search result informing the inquirer that the estate documents are stored on the system 20. Such output may be associated with the temporary inquirer account 49 and via the public portal 29.

In another embodiment, as part of the initial search the inquirer must enter basic information about themselves, such as their name. And as part of the search, the inquirer's name will be included as a required criterion to match one of the named parties. Thus, there will only be a search hit if the testator basic information matches a stored set of estate documents and the inquirer is included as a named party in the estate documents. The search result output 76, then, can inform the inquirer both of the presence of the estate documents on the administrator system 20 and that the inquirer is a named party therein. In some embodiments the inquirer can be required to enter additional non-vital information about themselves to give some verification that their interest in the estate documents is appropriate, and to verify their identity. For example, the inquirer, in addition to entering their name, can be required to enter their relationship to the testator, such as child, sibling, or friend. Such information about named parties would have been entered by the testator when establishing the account and for upload to the first database 30.

In some embodiments the inquirer account 49 can be non-temporary, and can even be password-protected so as to provide security for the inquirer. Preferably, the information submitted and saved on the inquirer account 49 is non-vital information, and includes the information entered as search criteria. In some embodiments the inquirer can enter some contact information. Other data, such as a search history, can also be saved and associated with the inquirer account 49. Preferably, however, the inquirer account 49 is not maintained in the first database 30, but is maintained in the second database 32 or another database.

The initial search is intended to verify that estate documents matching the search criteria concerning the testator are saved on the administrator's system 20. Preferably the search is performed using information in the second database 32, and there is no access to the first database 30. As such, the public portal 29 can only access information on the second database 32, which information has limited scope and includes little, if any, vital information.

After an initial search has confirmed the existence of estate documents saved on the administrator's system 20, the inquirer will be given the opportunity to obtain additional information, but only if the testator has indicated, while setting the rules 60 (see FIG. 3), that such additional information can be obtained. In all instances, the system 20 will check the various rules set during account setup (or later amended) before taking actions, and in this instance the system 20 will check the rules to see whether the public search option has been enabled. If the testator has not enabled a public search option, then no information about the estate documents beyond the fact that they are stored on the administrator system 20 can be obtained through the public portal 29. Or, in another embodiment, no information will be provided beyond the fact that the estate documents are stored on the system 20 and the inquirer is a named party.

If, however, the testator has enabled the public search option, the inquirer will then be able to enter 78 an additional submission identifying himself or herself. Such submission, however, preferably will not include vital information, but can include information such as the nature of the inquirer's relationship with the testator, such as son, daughter, brother, sister, friend, or the like. In addition, or as the additional submission, there can be a requirement of paying a fee. Upon entry 78 of the additional submission, a secondary search 80 may be performed. Such secondary search 80 will still be performed using the data stored in the second database 32. If information (if submitted) in the additional submission continues to match a saved record, the secondary search 80 will output 82 not only the existence of the estate documents saved on the system 20, but also the confirmation that the inquirer is a named party in the estate documents and the capacity or capacities of the inquirer in the estate documents. This information will be taken from the tables saved in the second database 32 (which included information pushed to the second database 32 from the first database 30). Notably, in additional embodiments rules can be set to enable or disable a particular named party's ability to request a secondary search 80, and thus depending on rules set by the testator, individual named parties may have different levels of search access granted.

In another embodiment, an inquirer can perform a search based only on the inquirer's own name and information. For example, an inquirer can enter their name and the system will check the database and, if it is determined that the inquirer is a named party in a stored estate document, the system will return a result confirming that the inquirer is named in an estate document. However, the system 20 will not necessarily reveal the identity of the testator. It is anticipated that, in most cases, inquirer names are not totally unique, and more information than just the name will be necessary to confidently conclude that the inquirer is in fact the named party of a particular estate document. Thus, the inquirer can be prompted to enter additional information about themselves-particularly non-vital information such as genealogical relationships. When such multiple data points can be compared with saved data, greater confidence can be had in the system's conclusion that the inquirer is a named party in an estate document. In such embodiments, a secondary search 80 can output 82 additional information, such as the name of the testator in whose estate documents the inquirer is named, the inquirer's capacity in such estate documents, and the like.

Continuing with reference to FIG. 4, when a search output 76, 82 determines that a particular testator's estate documents are saved on the administrator server 20, the search portal 29 can prompt the inquirer to report the testator's death, and the inquirer thus can report 84 the death via the search portal 29. In response, the portal 29 can obtain and output 86 request documents for the inquirer to download in order to formally request a formal copy of the estate documents. In some embodiments the request documents can be generic documents for the inquirer to fill out. In additional embodiments the system can automatically partially fill out the request documents to include the search criteria, and in some variations the record number, so as to ensure the request documents match the search request criteria. The system can also separately provide the record number to the inquirer along with the request documents. In some embodiments, during the step 60 of setting rules, the testator chooses which of the named parties are eligible to request and obtain a copy of the estate documents. Thus, prior to providing 86 request documents to the inquirer, the system 20 will check the inquirer's identity against the rules and only provide 86 the request documents if the rules allow the inquirer to request documents.

In current embodiments, submission of the request documents to the administrator is not performed online. Rather, the request documents are to be both signed by the inquirer and notarized so as to ensure accuracy and validity of the request and to confirm the identity of the inquirer. Also, the request documents are to be accompanied with a death certificate, preferably an original or certified copy of the death certificate. Such signed and notarized request documents can then be submitted/sent 88 to the administrator, who will validate 90 such request documents and provide a paper, certified alternate original of the estate documents that is printed, certified/embossed, and mailed to the inquirer/requestor. Such certified alternate original estate documents can be configured to meet the legal requirements of the associated jurisdiction. In some embodiments, once certified alternate original estate documents have been provided, the administrator system 20 will remove the testator from the data on the second database 32 so that the testator will no longer be part of searched data.

With continued reference to FIG. 4, in some embodiments, when an inquirer reports 84 the death of a testator that has been identified by a search result, an alert identifying the testator, such as via the record number, is generated 92 in the server system 24. Upon generation 92 of the death alert, the server system 24 can direct a notification to the administrator system 22. The administrator system 22 can then add information about the death report, such as the report itself, a reported date, and the name of the reporting inquirer, into the table associated with the estate documents in the first database 30 so that the death report is saved.

In some embodiments, a notification of the death report is generated 92 by the server system 24. The notice preferably is pushed to the administrator account 40, corresponding custodian account 42 (if relevant) and the corresponding user account 46. Notably, providing a notification to the user account 46 may expose a false death report, as a living testator would be notified of the death report.

In yet another embodiment, upon generation 92 of the alert, the server system 24 can direct entry of the death report-preferably along with the name of the reporting inquirer-into the tables associated with the estate documents in the first database 30. Preferably, before any information is provided to or saved on the tables in the first database 30, the server system 24 evaluates the alert data to ensure formatting and such is configured correctly in order to prevent security lapses from providing information to the first database 30. In another embodiment, upon entry of a death report alert, the notification generation comprises a data message comprising the record number, inquirer name and notation of death report pushed from the second database 32 to the first database 30, along with an alert.

In some embodiments, while setting rules 60, the testator may signal a desire to be notified when their estate documents are identified in a search output 76, 82. The system 20 logs 94 search outputs 76, 82, and if a saved testator record is identified in the search output 76, 82, the system 20 determines whether the testator's rules request notification of searches identifying the testator. If the testator has so indicated, a notification is generated 92 and provided to the user account 46, providing information about the search, including the name of the inquirer. The testator can also set the rules so that the notification is provided to the custodian account 42. Further, rules can be set by the testator so that, for example, a notification is generated upon output 82 of a secondary search, but not upon output 76 of an initial search.

In some embodiments, while setting rules 60, the testator can determine that the estate documents can be obtained only from a professional services firm that is associated with the custodian account 42. As such, in the event the testator has set such a rule, at step 86, rather than providing request documents to the inquirer, the system 20 will obtain the inquirer's contact information and pass it along to the custodian account 42. Alternatively, or in addition, the system may simply provide the inquirer with contact information regarding the professional services firm corresponding to the custodian account 42, which contact information may have been pushed to the second database 32 upon account creation.

The embodiments discussed above have disclosed structures with substantial specificity. This has provided a good context for disclosing and discussing inventive subject matter. However, it is to be understood that other embodiments may employ different specific structural shapes and interactions.

For example, in yet another embodiment, the administrator can maintain a physical repository including physical originals of estate documents. However, other applicable features, such as online information about the estate documents calculated to enable named parties to locate and request such documents can remain in place. A main difference of such an embodiment would be that when an inquirer submits a proper document request the administrator will provide the original physical copy that had been kept in storage rather than a certified alternative original.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above.

1. A computer-implemented method, comprising:
storing, in a first database, an estate document, a testator information about a testator associated with the estate document and a named party information, the estate document having one or more named parties, storing comprising using a security protocol and apparatus that limits access to the first database to qualified accounts;
the testator information comprising a testator name, a testator vital information, and a testator non-vital information;
the named party information including a name of each of the one or more named parties, and a capacity of each of the one or more named parties;
storing, in a second database, a copy of at least a portion of the testator information and the named party information that is stored in the first database;
receiving an online search request from an inquirer, the online search request comprising a search testator name, a search testator vital information, and the inquirer name;
performing a search in response to the search request, wherein performing the search comprises reviewing the second database and not the first database;
determining that the search testator name matches the testator name, the search testator vital information matches the testator vital information, and the inquirer name matches at least one of the names of the one or more named parties as stored in the second database; and
outputting an acknowledgement that the estate document is stored in the first database and that the inquirer is one of the one or more named parties.

2. The computer-implemented method of claim 1, comprising receiving the estate document, testator information and named party information via a secured interface.

3. The computer-implemented method of claim 2, comprising pushing at least a portion of the testator information and named party information from the first database to the second database.

4. The computer-implemented method of claim 3, wherein the second database is blocked from initiating communication with the first database.

5. The computer-implemented method of claim 4 additionally comprising outputting the capacity of the inquirer.

6. The computer-implemented method of claim 5 additionally comprising notifying a testator user account that the system has outputted the acknowledgement that the estate document is stored in the database and that the inquirer is one of the one or more named parties

7. The computer-implemented method of claim 3, wherein the named party information additionally comprises non-vital information about the named party.

8. The computer-implemented method of claim 7, wherein the named party information pushed to the second database is only non-vital information.

9. The computer-implemented method of claim 7, wherein the named party information additionally comprises identification of at least one genealogical relationship of the named party.

10. A computer-implemented method, comprising:
storing, in a first database, an estate document, a testator information about a testator associated with the estate document and a named party information, the estate document having one or more named parties, storing comprising using a security protocol and apparatus that limits access to qualified accounts;
the information about the testator comprising a testator name, a testator vital information, and a testator non-vital information;
the named party information including a name of each of the one or more named parties, and a capacity of each of the one or more named parties;
receiving instructions under the security protocol, and in response to the instructions copying at least a portion of the testator information and at least a portion of the named party information from the first database to a second database that is accessible via a public search portal, the public search portal being limited to accessing the second database;
receiving an online search request from an inquirer via the public search portal, the online search request comprising a search testator name, a search testator vital information, and the inquirer name;
searching, via the public search portal the second database, and determining that the search testator name matches the testator name stored in the second database, the search testator vital information matches the testator vital information stored in the second database, and the inquirer name matches at least one of the names of the one or more named parties stored in the second database; and
outputting an acknowledgement that the estate document is stored in the first and that the inquirer is one of the one or more named parties.

11. The computer-implemented method of claim 10 additionally comprising the inquirer entering a relationship between the inquirer and the testator.

12. The computer-implemented method of claim 11, wherein the named party information includes a stored relationship between each of the one or more named parties and the testator.

13. The computer-implemented method of claim 12 additionally comprising determining that the relationship entered by the inquirer matches the stored relationship between the testator and the at least one of the names of the one or more named parties.

14. (canceled)

15. The computer-implemented method of claim 10, wherein the public search portal can be accessed without requiring security credentials.
